(19) United States
(12) Patent Application Publication
(10) Pub. No.: US 2007/0034580 A1
(43) Pub. Date: Feb. 15, 2007

(54) Fluid filter arrangement including valve arrangement and methods

(76) Inventors: Matthew L. Stein, Northfield, MN (US); Michael Dean Carlson, Waconia, MN (US)

Correspondence Address: MERCHANT & GOULD PC, P.O. BOX 2903, MINNEAPOLIS, MN, 55402-0903, US

(21) Appl. No.: 11/202,737

(22) Filed: Aug. 11, 2005

(51) Int. Cl. B01D 27/00

(52) U.S. Cl. 210/791; 210/232; 210/440

(57) ABSTRACT

A valve assembly includes a retainer, a knob connected to the retainer, and a seal member. A filter arrangement includes a housing, a media pack operably oriented in the interior volume of the housing, a retainer operably oriented in a valve opening in the housing, a knob, and a seal member. The retainer defines a knob-receiving bore. The knob includes a base external to the housing and defines a drain hole. The knob also includes a tube extending from the base and through the knob-receiving bore into the interior volume of the housing. The tube defines an open interior in fluid communication with the interior volume of the housing, and an aperture arrangement to provide fluid communication between the tube open interior and a region external to the tube. The seal member is axially moveable relative to the housing to selectively form a seal between the base of the knob and a sealing surface of the housing. A method of draining a filter member includes rotating a knob relative to a retainer held by a filter housing to: release a seal between the knob and the housing; open a fluid channel between an interior of a tube and a drain hole and a base of the knob; and open a vent hole extending through the tube, the vent hole being located between a free end of the tube and the fluid channel.

### TECHNICAL FIELD

This disclosure relates generally to fluid filters, drainage valves, and methods. In certain particular embodiments shown, it relates to fluid filters of the spin-on type. In some applications, the disclosure relates to a drainage valve for in a fluid vessel or a fluid filter, such as a fuel filter. Methods of accomplishing drainage techniques are provided.

### BACKGROUND

Filters have been employed in a variety of applications including hydraulic systems, fuel systems, and engine lubrication systems. Such filters may generally be “spin-on” type filters and include a filter element within a can or housing having a cover or attachment plate at one end by which the filter can be screwed onto or off of a filter head. A central opening and several surrounding openings in the cover are typically provided to direct flow through the filter and filter element therein, which flow can be either an inside/out (reverse flow) or outside/in (forward flow) direction relative to the filter element. Spin-on filters are usually used only once before removal and replacement.

Fluid filters may include fuel/water separators. In a fuel/water separator, water is separated from a fuel/water mixture, in order to prevent damage to downstream engine components. Fluid filters that remove water will tend to accumulate the separated water by gravity at the bottom of the housing. The water should eventually be removed from the housing. Some models of liquid filters incorporate a mechanism to remove the water from the housing by using a pipe plug or a petcock. Typically, a threaded shaft is used to actuate these mechanisms. That is, the shaft is turned to move it linearly away from and out of the housing, until separation from the housing. They often require several turns, until separated from the housing. Often, the device begins to drain fluid as soon as it becomes unseated or loosened. The leaking fluid may run onto the operator's hand and down the arm as the device is turned the additional revolutions to the open, or separated, position. When the mechanism is to be closed, the operator is exposed to the fluid as the threaded shaft or plug is rotated several turns before it becomes closed or seated. These devices may often incorporate wrench flats or knurled covers to transmit the high amount of torque required to compress a seal to prevent leakage. A similar amount of torque may often be required to break the device free before it can be rotated by hand. Improvements are desirable.

### SUMMARY

A valve assembly is described that can be used for a filter or any type of fluid vessel. In general, the valve assembly includes a retainer, a knob connected to the retainer, and a seal member. In one embodiment shown, the retainer defines a knob-receiving bore. The knob has a base with a tube extending from it, and the tube extends through the knob-receiving bore. In one embodiment shown, the base defines a drain hole. In the one shown, the tube defines an open interior and an aperture arrangement to provide fluid communication between the open interior and a region external to the tube. Also in the one shown, the seal member circumscribes the tube and is axially located between the knob and the retainer. The seal member can be radially located between the base drain hole and the tube.

In another aspect, this disclosure describes a filter arrangement including a housing, a media pack operably oriented in the interior volume of the housing, a retainer operably oriented in a valve opening in the housing, a knob, and a seal member. In the one shown, the retainer defines a knob-receiving bore. In the example shown, the knob includes a base external to the housing and defining a drain hole. In the one shown, the knob also includes a tube extending from the base and through the knob-receiving bore into the interior volume of the housing. In the one shown, the tube defines an open interior in fluid communication with the interior volume of the housing, and an aperture arrangement to provide fluid communication between the tube open interior and a region external to the tube. The seal member, in the example shown, circumscribes the tube and is external of the housing. The seal member is axially moveable relative to the housing to selectively form a seal between the base of the knob and a sealing surface of the housing.

In another aspect, this disclosure describes a method of draining a filter member including a housing containing a media pack. The method includes rotating a knob relative to a retainer held by a filter housing to: release a seal between the knob and the housing; open a fluid channel between an interior of a tube and a drain hole and a base of the knob; and open a vent hole extending through the tube, the vent hole being located between a free end of the tube and the fluid channel. In the embodiment shown, the tube extends into a bore of the retainer and into an interior volume of the housing.

### BRIEF DESCRIPTION OF THE DRAWINGS

FIG. 1 is a cross-sectional view of a filter arrangement having a valve assembly, the valve assembly being in a closed position; the cross-section being taken along the line 1-1 of FIG. 3;

FIG. 2 is a cross-sectional view of the filter arrangement of FIG. 1, depicting the valve assembly in an open position constructed according to principles of this disclosure; FIG. 3 is a top plan view of the filter arrangement of FIGS. 1 and 2;

FIG. 4 is a side elevational view of the filter arrangements of FIGS. 1 and 2;

FIG. 5 is an exploded, perspective view of the filter arrangement of FIGS. 1-4;

FIG. 6 is a cross-sectional view of the valve assembly utilized with the filter arrangement of FIGS. 1 and 2;

FIG. 7 is a perspective view of a knob utilized in the valve assembly of FIG. 6;

FIG. 8 is a cross-sectional view of the knob depicted in FIG. 7, the cross-section being taken along the line 8-8 of FIG. 9;

FIG. 9 is a top plan view of the knob depicted in FIGS. 7 and 8;

FIG. 10 is a cross-sectional view of the knob depicted in FIG. 9, the cross-section being taken along the line 10-10 of FIG. 9;

FIG. 11 is a perspective view of a retainer utilized in the valve assembly of FIG. 6;

FIG. 12 is a cross-sectional view of the retainer depicted in FIG. 11, the cross-section being taken along the line 12-12 of FIG. 13;

FIG. 13 is a top plan view of the retainer depicted in FIG. 11;

FIG. 14 is a side elevational view of the retainer depicted in FIGS. 11-13;

FIG. 15 is a bottom plan view of the retainer depicted in FIGS. 11-14; and

FIG. 16 is a bottom plan view of the housing with the retainer installed therein and without the knob installed therein.

### DETAILED DESCRIPTION

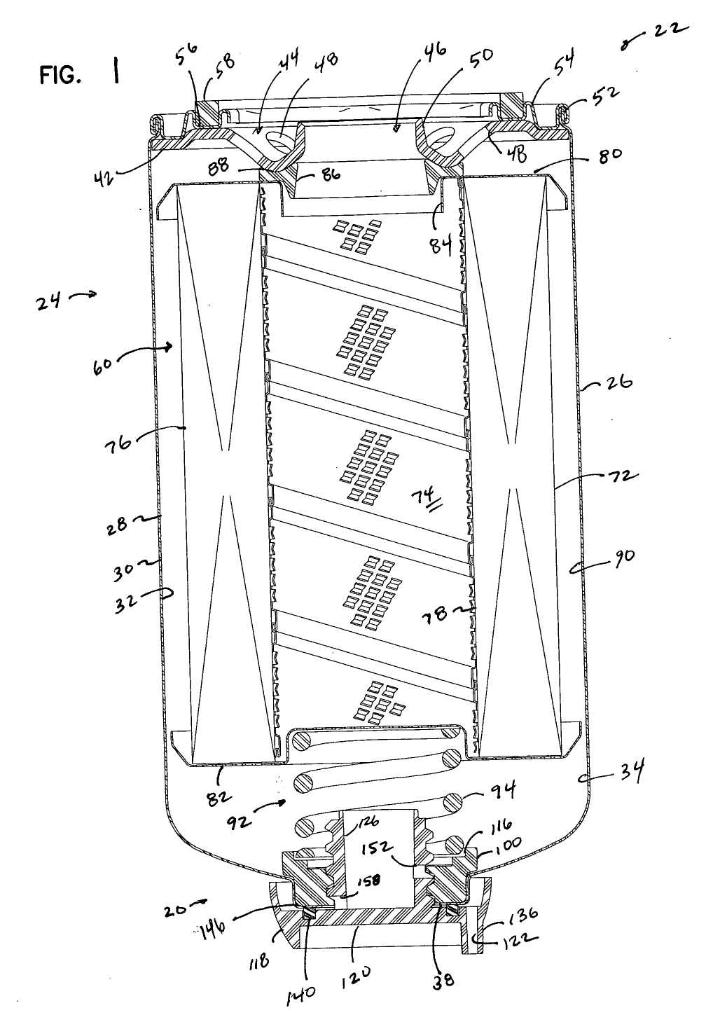

FIG. 6 depicts a valve assembly generally at 20. The valve assembly 20 can be utilized in many different applications including fluid vessels, tanks for holding liquid, and fluid filters, for example, filters for liquids. In the particular embodiment illustrated in these drawings, the valve assembly 20 is shown utilized with a filter arrangement 22 (FIGS. 1-5). The filter arrangement 22 can be used for many types of filtration. For example, the filter arrangement 22 can be an oil filter, a hydraulic filter, a fuel filter, or a fuel/water separator. The particular embodiment shown is a fuel filter 24. Fuel filters 24 are typically operable between vacuum pressures and about 100 psi.

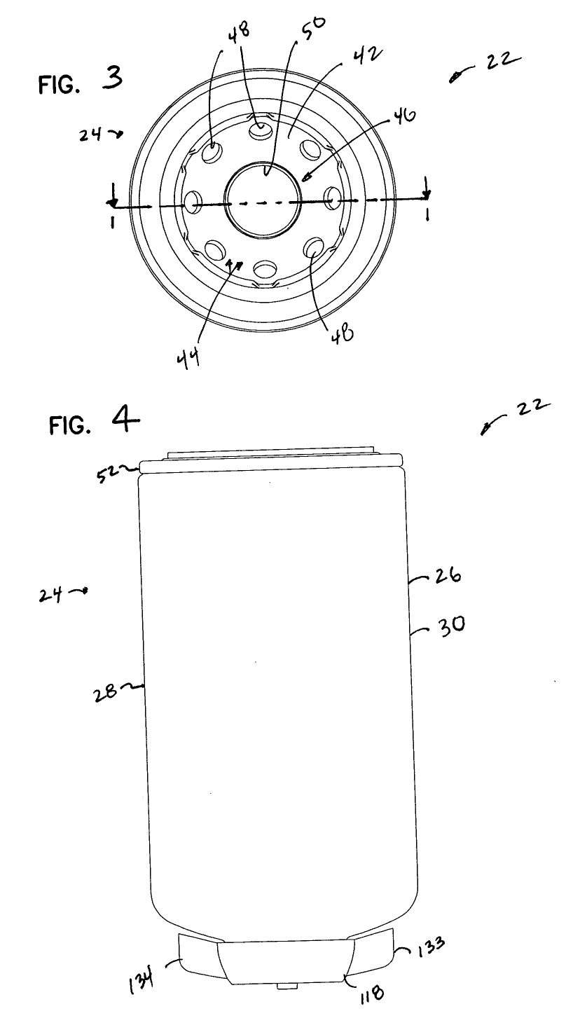

In reference now to FIGS. 1-5, the filter arrangement 22 depicted includes a housing 26. The housing 26 is typically a thin-walled construction, which can be metal or plastic. The housing 26 has a wall 28 with an outer, exterior surface 30 and an inner surface 32. The housing wall 28 defines an interior volume 34. The housing 26 also has an open end 36 (FIG. 5). Opposite of the open end 36 is a valve opening 38.

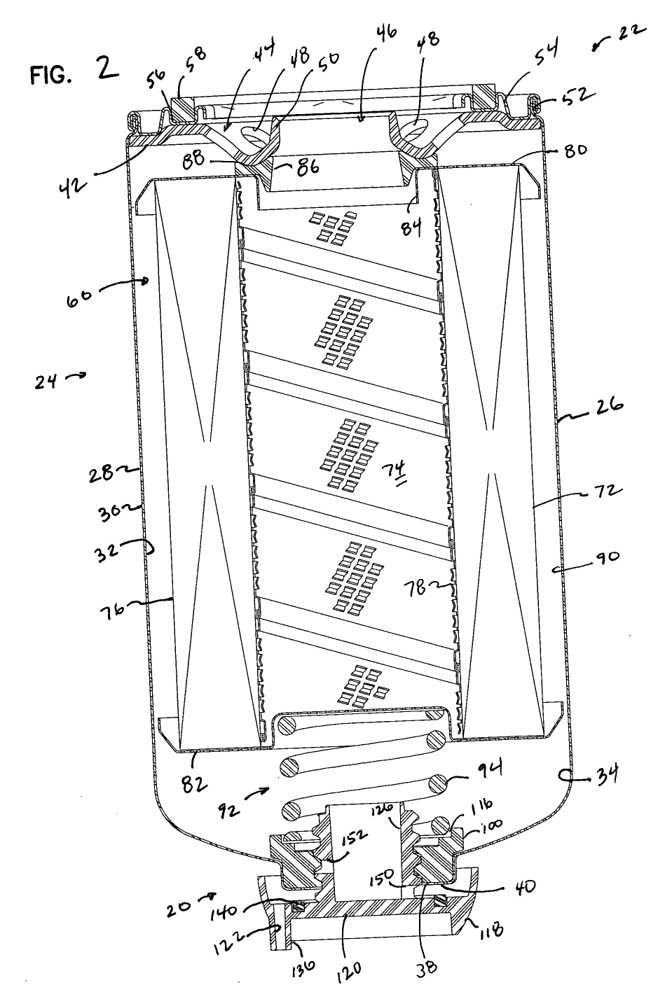

The housing 26 further defines a sealing surface 40 (FIG. 2) on the external surface 30 that circumscribes or surrounds the valve opening 38. The sealing surface 40 functions to provide a surface against which a seal can be releasably formed between the valve assembly 20 and the housing 26. This is described further below.

At the open end 36 of the housing 26, the filter arrangement 22 includes a baffle plate 42. The baffle plate 42, in the arrangement shown, defines an inlet arrangement 44 and an outlet arrangement 46. In the embodiment shown, the inlet arrangement 44 includes a plurality of inlet apertures 48, while the outlet arrangement 46 includes a single, outlet tube 50. The arrangement shown is for a forward-flow system. In other embodiments, the inlet arrangement 44 and outlet arrangement 46 can be reversed, to provide a reverse-flow system.

The baffle plate 42 is secured to the housing 26 by a roll seam 52 between the housing 26 and an end portion 54 of the housing 26. The end portion 54 forms a sealing groove 56 to hold a seal member 58. The seal member 58 circumscribes both the inlet arrangement 44 and the outlet arrangement 46. In preferred embodiments, the seal member 58 provides an axially directed seal between the filter arrangement 22 and a filter head operably disposed to receive the filter arrangement 22.

The filter arrangement 22 further includes a media pack 60 operably oriented in the interior volume 34 of the housing 26. The media pack 60 can be of any type of filtration media suitable for the application. The media pack 60 can also be in a variety of geometries. In the particular embodiment shown, the media pack 60 is a cylindrical region of media 72 defining an open filter interior 74. In many preferred embodiments, the media pack 60 will be formed from pleated media 76. In the embodiment illustrated, the media pack 60 is supported by a porous inner support or liner 78. The media pack 60, in the embodiment shown, is illustrated as being secured to and between a first end cap 80 and a second end cap 82. The first end cap 80 defines an opening 84 to provide fluid communication with the open filter interior 74. In the embodiment shown, the second end cap 82 is a closed end cap, which has no openings.

One type of pleated media 76 that can be used has the following characteristics: a resin content of 14-22%; an uncured basis weight of 82.5-102.5 lbs./3,000 ft.² (134.7-167.3 g/m²); a thickness of 0.017-0.027 in. (0.43-0.69 mm); a corrugation depth of 0.010-0.018 in. (0.26-0.46 mm); a first bubble point of 7.5-10.5 in. (191-267 mm); a volatile content of 4.8-9.8%; a dry Mullen burst of 15 psi (103 kPa) minimum; a stiffness of 3,500 mg minimum; a permeability of 6-16 ft./min. (1.9-4.9 m/min.); and a water repellency of 7.7 in. (196 mm) minimum. Another useful pleated media 76 will have three polyester melt blown layers and a protective layer of polyester scrim bonded together with ultrasonic lamination; a composite basis weight of 175 lbs./3,000 ft.² (285 g/m²); a thickness of about 0.049 in. (1.2 mm); and a permeability of about 2.4 ft./min. (0.73 m/min.).

Between the first end cap 80 and the baffle plate 42 is a seal member 86. The seal member 86 forms an axially directed seal 88 between the first end cap 80 on the media pack 60 and the baffle plate 42. The seal 88 separates the unfiltered liquid from the filtered liquid. In forward-flow systems, the filtered liquid will be in the open filter interior 74, while the unfiltered liquid will be part of the unfiltered liquid volume 90 that is downstream of the inlet arrangement 44 and upstream of the media pack 60. The seal member 86 is biased in a direction toward the baffle plate 42 to help hold the seal 88 by a biasing member 92, illustrated in the drawings as a spring 94.

In operation, the filter arrangement 22 has unfiltered liquid provided to it, through, for example, a filter head, which enters the filter arrangement 22 through the inlet arrangement 44. The unfiltered liquid flows through the inlet apertures 48 of the baffle plate 42 and into the unfiltered liquid volume 90. The unfiltered liquid is not allowed to pass to the open filter interior 74 without first flowing through the pleated media 76 due to the seal 88. The unfiltered liquid flows through the pleated media 76, which helps to purify and remove particulate and other debris from the liquid. The filtered liquid then reaches the open filter interior 74, which then passes through the outlet tube 50 of the outlet arrangement 46. From there, it enters a filter head and is used by downstream equipment.

As mentioned above, in the embodiment shown, the filter arrangement 22 utilizes the valve assembly 20. The valve assembly 20 is operably associated with the filter arrangement 22 to selectively drain liquid from the interior volume 34 of the housing 26. When the filter arrangement 22 is fuel filter 24, the liquid drained from the housing 26 is usually water, or a water/fuel mixture. FIG. 1 shows the valve assembly in a closed position, while FIG. 2 shows the valve assembly 20 is an open position. In the closed position, liquid is prevented from draining from the housing 26. In the open position, FIG. 2, liquid is permitted to be drained from the housing 26.

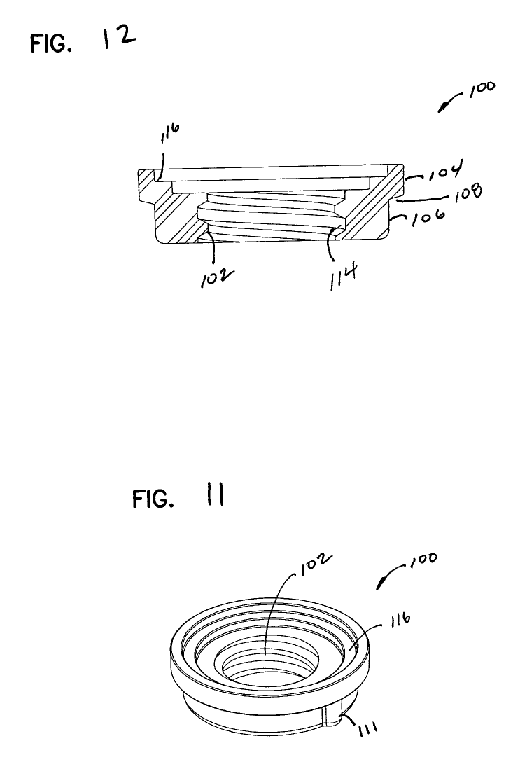

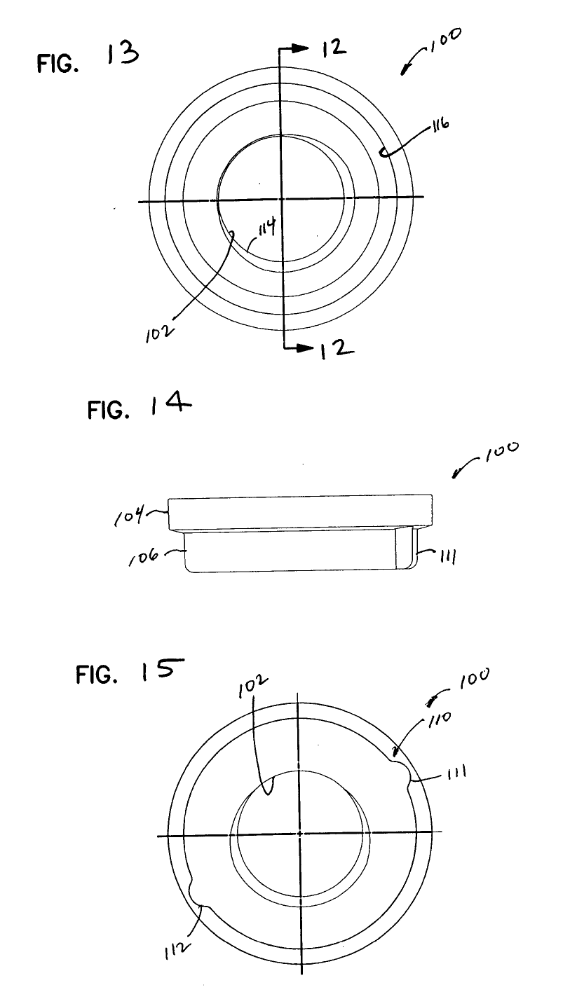

In the embodiment illustrated, the valve assembly 20 includes a retainer 100 defining a knob-receiving bore 102 (FIG. 12). In the embodiment shown, the retainer 100 is generally cylindrical with at least two outer diameters. A first region 104 has a larger outer diameter than a second region 106 to define a shoulder or step 108 therebetween. This stepped arrangement helps to hold the retainer 100 in place in the valve opening 38 in the housing 26. The second region 106 further defines a ear arrangement 110 (FIG. 15). The ear arrangement 110 cooperates with the housing wall 28 to prevent rotation of the retainer within the valve opening 38 of the housing 28. In the embodiment shown, the ear arrangement 110 includes at least first and second ears 111, 112 as a rounded projection extending from the second region 106 of the retainer 100.

In the embodiment illustrated, the retainer 100 defines threads 114 along the knob-receiving bore 102 (FIG. 12). The threads 114 can be any type of threads, but the illustrated embodiment shows cam threads. In the embodiment shown, the threads 114 are along the bore 102 within the second region 106 of the retainer 100.

When the retainer 100 is operably installed within the valve opening 38 of housing 26, the retainer 100 defines a seat 116 for the spring 94.

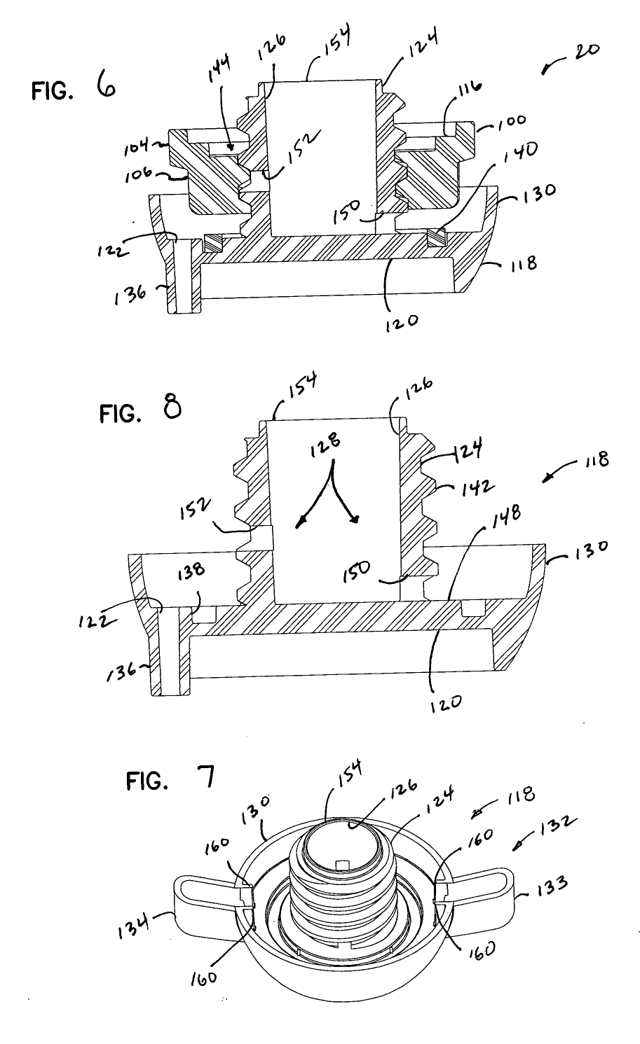

The valve assembly 20, in the embodiment shown, also includes a knob 118. In the embodiment shown, the knob 118 can be rotatably connected to the retainer 100. In the embodiment shown, the knob 118 includes a base 120 defining a drain hole 122 (FIG. 8). A tube 124 is part of the knob 118 and extends from the base 120 and through the knob-receiving bore 102 of the retainer 100. The tube 124 defines an open interior 126 and an aperture arrangement 128 to provide fluid communication between the open interior 126 and a region external to the tube 124.

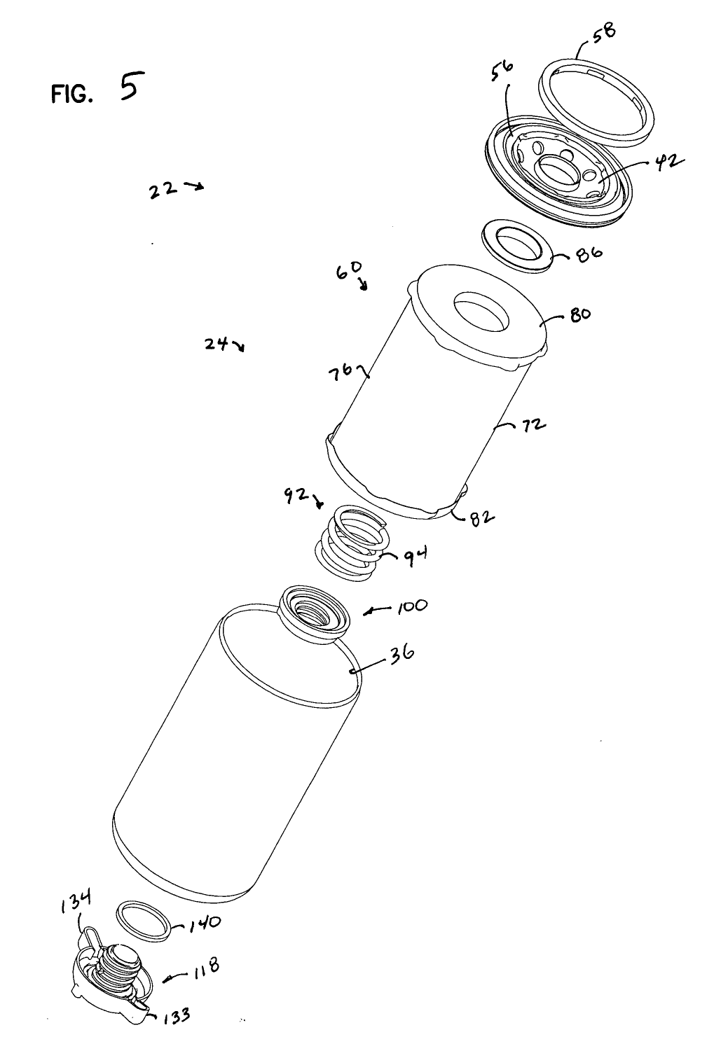

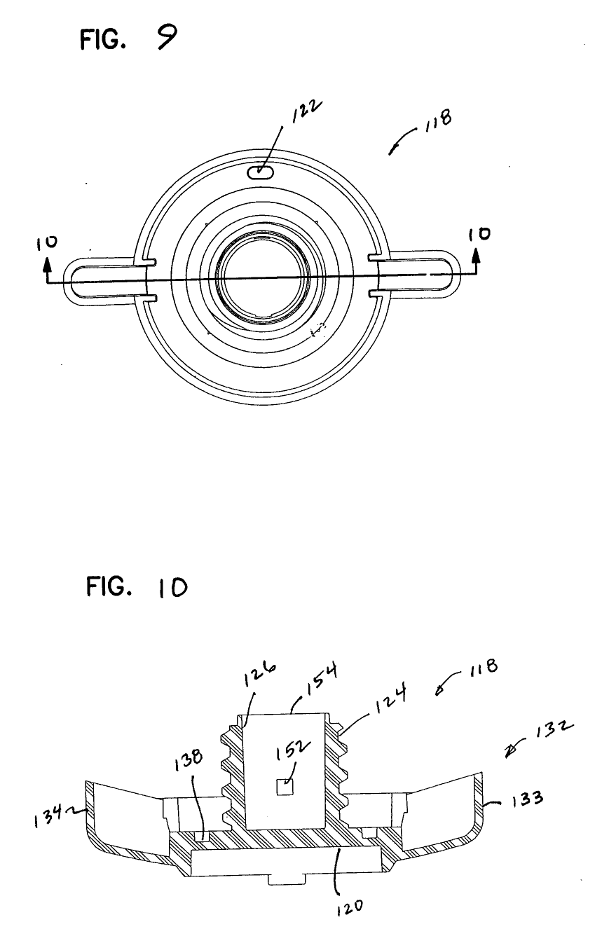

In reference now to FIGS. 7-10, the knob 118 depicted further includes a wall 130 extending from and circumscribing the base 120. FIGS. 7 and 8 show the wall 130 extending in a same direction as the tube 124 extends from the base 120. The wall 130 helps to contain liquid drained from the filter arrangement 22 within the knob 118 and directed toward the drain hole 122.

Extending from the wall 130, in the embodiment shown, is a wing arrangement 132. The wing arrangement 132 radially projects from the wall 130. In the embodiment shown, the wing arrangement 132 includes first and second wings 133, 134 to provide structure that can be grasped by a human hand, or by a tool, to allow the knob 118 to be rotated relative to the retainer 100 and the filter arrangement 22.

In the particular embodiment shown, the knob 118 further includes a hollow stem or column 136 axially projecting from the base 120 in a direction opposite of the tube 124 and in a direction opposite of the wall 130. The hollow column 136, in the embodiment shown, defines the drain hole 122. In certain uses, the column 136 can be connected to a hose or other tubing if it is desired to direct the fluid being drained from the filter arrangement 22 to another location.

In the embodiment shown, the base 120 further defines a groove 138 circumscribing the tube 124. In the specific embodiment depicted, the groove 138 is located radially between the drain hole 122 and the tube 124. The groove 138, in the embodiment shown, supports a seal member 140.

In general, the valve assembly 20 includes seal member 140. The seal member 140 is axially located between the knob 118 and the retainer 100. In the embodiment depicted, the particular seal member 140 shown is radially located between the drain hole 122 in the base 120 and the tube 124. In the particular embodiment illustrated, the seal member 140 is held within the groove 138. The function of the seal member 140 is described further below.

In the embodiment shown, the tube 124 has structure to allow the knob 118 to rotatably connected to the retainer 100. In the embodiment shown, the tube 124 has threads 142 along its outer surface for mating with the threads 114 in the knob-receiving bore 102. In preferred embodiments, the threads 142 are cam threads. The threads 142 on the tube 124 and the threads 114 in the knob-receiving bore 102 result in a threaded connection 144 (FIG. 6) between the retainer 100 and the knob 118. The threaded connection 144 between the retainer 100 and the knob 118 allows the knob 118 to be moved axially toward and away from the retainer 100.

When the valve assembly 20 is operably installed within the filter arrangement 22, as shown in FIGS. 1 and 2, rotation of the knob 118 causes the knob 118 to move toward and away from the retainer 100 and the sealing surface 40 (FIG. 2) of the housing 26. This axial motion of the knob 118 also causes the seal member 140 to move toward and away from the sealing surface 40. When the knob 118 is rotated such that the seal member 140 is compressed against the sealing surface 40, a seal 146 (FIG. 1) is formed between and against the sealing surface 40 of the housing 26 and the base 120 of the knob 118.

FIG. 1 depicts the valve assembly 20 when it is in a “closed” position. A “closed” position is one in which the seal 146 is in place between the valve assembly 20 and the filter arrangement 22. FIG. 2 depicts the valve assembly 20 in an “open” position. In an “open” position, the seal member 140 is located relative to the sealing surface 40 such that it is axially spaced away from the sealing surface 40, and the seal 146 is not present. The open position is formed by rotating the knob 118 relative to the retainer 100 to axially move the knob 118 holding the seal member 140 away from the sealing surface 40. It should be appreciated that the valve assembly 20 is constructed such that it can move between the closed position of FIG. 1 and the open position of FIG. 2 selectively back-and-forth, upon rotation of the knob 118.

Preferably, the valve assembly 20 is designed to be able to move from the closed position to the open position by rotating the knob 118 by 180 degrees or less. The use of cam threads 114 is helpful in allowing the valve assembly 20 to be moved between the closed position and open position by rotation of the knob 118 at 180 degrees or less. In preferred embodiments, the knob 118 is rotated about 180 degrees.

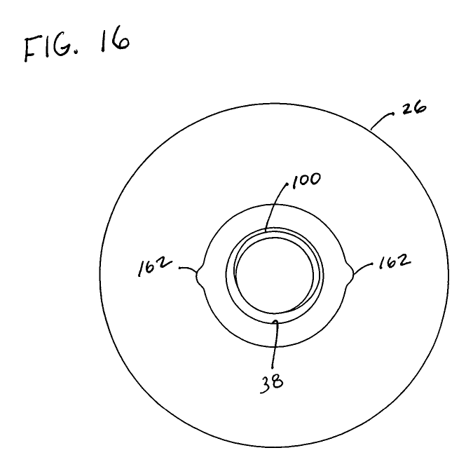

In some embodiments, the filter arrangement 22 is constructed and arranged to result in an audible “click” when the valve assembly 20 is moved to the open position. As embodied herein, the knob 118 includes tabs 160 (see FIG. 7) projecting radially inwardly from the wall 130 of the knob 118. In the embodiment shown in FIG. 7, in particular, the tabs 160 project radially inwardly from the wall 130 defining the first and second wing 133, 134. The tabs 160 engage protrusions 162 (FIG. 16) formed in the housing 26. In FIG. 16, it can be seen how the housing 26 has a pair of the protrusions 162 extending as bumps radially outwardly from a portion of the housing 26 defining the valve opening 38. When the knob 118 is operably oriented within the retainer 100, and when the knob 118 is rotated from its closed position to its open position, the tabs 160 (FIG. 7) engage the protrusions 162 and result in an audible “click” noise. This audible click provides a signal to the user that the valve assembly 20 has been moved to an open position.

As mentioned above, the tube 124 defines aperture arrangement 128. The aperture arrangement 128 is provided to allow liquid to drain from the open interior 126, into a channel 148 (FIG. 8), and then through the drain hole 122. The channel 148 is defined by the base 120 between the tube 124 and the wall 130. The aperture arrangement 128 also allows for venting to help facilitate draining of the filter arrangement 22 or whatever vessel is being drained. In the embodiment shown, the 30 aperture arrangement 128 includes at least a first aperture 150 extending through the tube 124. In the embodiment shown, the at least first aperture 150 is adjacent to the base 120. In the embodiment shown, the aperture arrangement 128 further includes at least a second aperture 152, or vent hole, extending through the tube 124 and located axially between the first aperture 150 and a free end 154 of the tube 124. In preferred embodiments, the at least second aperture 152 will be oriented vertically above the first aperture 150, when the vessel or filter arrangement 22 is oriented for draining. The second aperture 152 allows air external of the filter arrangement 22 to enter the interior volume 34 through the threaded connection 144 and then through the second aperture 152, while liquid is draining through the first aperture 150.

A method for draining the filter arrangement 22 can now be appreciated. The method includes rotating the knob 118 relative to the retainer 100 held by the filter housing 26 to release the seal 146 between the knob 118 and the housing 26. When the seal 146 is released, fluid channel 148 is opened between the interior 126 of the tube 124 and the drain hole 122 in the base 120 of the knob 118. The tube 124 extends through the knob-receiving bore 102 of the retainer 100 and into the interior volume 34 of the housing 26. The step of releasing the seal 146 also opens the vent hole 152 extending through the tube 124. The vent hole 152 is located between the free end 154 of the tube 124 and the fluid channel 148.

The step of rotating includes engaging cammed threads 114, 142 between an exterior surface of the tube 124 and the interior bore 102 of the retainer 100. Preferably, the step of rotating includes rotating the knob 118 from a closed position to a position not more than 180 degrees from the closed position to release the seal 146 between the knob 118 and the housing 26, open the fluid channel 148 between the interior 126 of the tube 124 and the drain hole 122 in the base 120 of the knob 118, and open the vent hole 152 extending through the tube 124.

Preferably, the step of rotating the knob 118 also includes engaging the knob 118 against a portion of the housing 26 to create an audible click. In particular, the step of rotating the knob 118 preferably includes engaging tabs 160 extending radially inwardly from the wall 130 of the knob 118 against protrusions 162 on the housing 26. This engagement results in a signal to the user that the valve assembly 20 is in an open position. The signal, in this embodiment, is an audible click.

The method further includes, after the step of rotating, allowing liquid to drain from the interior volume 34, through the open interior 126 of the tube 124, through the first aperture 150 into the channel 148, and through the drain hole 122, while allowing air to flow through the threaded connection 144 and through the vent hole 152 into the open interior 126 and into the interior volume 34 of the housing 26. Because air is lighter than water, a water/fuel mixture, or almost all liquids, the air will flow through any liquid that is collected within the open interior 26 of the tube 124 and enter into the interior volume 34. This allowance of air through the vent hole 152 helps to facilitate the draining of liquid from the interior volume 34 and open interior 126 through the aperture 150 into the channel 148 and through the drain tube 122.

In the embodiment shown, the step of allowing liquid to drain through the drain hole 122 includes allowing liquid to drain through the hollow column 136 extending from the base 120 in a direction opposite of the tube 124.

In the embodiment shown, the step of rotating the knob 118 includes grasping the wing arrangement 132 on the knob 118.

When the desired amount of draining is completed, the valve assembly 20 is moved from the open position (FIG. 2) to the closed position (FIG. 1) by rotating the knob 118 to axially move the knob 118 toward the sealing surface 40 until the seal member 140 is compressed against the sealing surface 40 to form the seal 146. The seal 146 closes the fluid channel 148 between the open interior 126 and the drain hole 122. The seal 146 also closes the air flow path through the threaded connection 144 and through the vent hole 152. When the valve assembly 20 is in the closed position of FIG. 1, the filter arrangement 22 can again be used for filtering operations.

What is claimed is:

1. A valve assembly comprising:
(a) a retainer defining a knob-receiving bore;
(b) a knob rotatably connected to the retainer; the knob including:
(i) a base; the base defining a drain hole;
(ii) a tube extending from the base and through the knob-receiving bore; the tube defining:
(A) an open interior;
(B) an aperture arrangement to provide fluid communication between the open interior and a region external to the tube; and
(c) a seal member circumscribing the tube; the seal member being:
(i) axially located between the knob and the retainer; and
(ii) radially located between the base drain hole and the tube.

2. A valve assembly according to claim 1 wherein:
(a) the knob further includes a wall extending from and circumscribing the base.

3. A valve assembly according to claim 2 wherein:
(a) the knob further includes a wing arrangement radially projecting from the wall.

4. A valve assembly according to claim 1 wherein:
(a) the knob further includes a hollow column axially projecting from the base in a direction opposite of the tube; the hollow column defining the drain hole.

5. A valve assembly according to claim 1 wherein:
(a) the base defines a groove circumscribing the tube and located radially between the drain hole and the tube;
(i) the seal member being seated within the groove.

6. A valve assembly according to claim 1 wherein:
(a) the tube has a free end opposite of the base; and
(b) the aperture arrangement includes:
(i) at least a first aperture through the tube and adjacent to the base; and
(ii) at least a second aperture through the tube and located axially between the first aperture and the free end of the tube.

7. A valve assembly according to claim 1 wherein:
(a) the knob-receiving bore defines threads, and an exterior portion of the tube defines threads to provide a threaded connection between the retainer and the knob.

8. A valve assembly according to claim 1 wherein:
(a) the retainer includes an ear arrangement radially projecting from an outer perimeter thereof.

9. A valve assembly according to claim 2 wherein:
(a) the knob further includes:
(i) a wing arrangement radially projecting from the wall; and
(ii) a hollow column axially projecting from the base in a direction opposite of the tube; the hollow column defining the drain hole;
(b) the base defines a groove circumscribing the tube and located radially between the drain hole and the tube;
(i) the seal member being seated within the groove;
(c) the tube has a free end opposite of the base; and
(d) the aperture arrangement includes:
(i) at least a first aperture through the tube and adjacent to the base; and
(ii) at least a second aperture through the tube and located axially between the first aperture and the free end of the tube.

10. A filter arrangement comprising:
(a) a housing defining an interior volume, a valve opening, and a sealing surface on an external surface of the housing circumscribing the valve opening;
(b) a media pack operably oriented in the interior volume of the housing; and
(c) a retainer operably oriented in the valve opening of the housing; the retainer defining a knob-receiving bore;
(d) a knob rotatably connected to the retainer; the knob including:
(i) a base external to the housing; the base defining a drain hole;
(ii) a tube extending from the base and through the knob-receiving bore into the interior volume of the housing; the tube defining:
(A) an open interior in fluid communication with the interior volume of the housing;
(B) an aperture arrangement to provide fluid communication between the tube open interior and a region external to the tube; and
(e) a seal member circumscribing the tube and external of the housing; the seal member being axially movable relative to the housing to selectively form a seal between the base and the sealing surface of the housing.

11. A filter arrangement according to claim 10 wherein:
(a) the seal member is located:
(i) axially between the knob and the retainer; and
(ii) radially between the base drain hole and the tube.

12. A filter arrangement according to claim 10 wherein:
(a) the media pack includes a cylindrical construction of pleated media being supported by an inner cylindrical porous liner.

13. A filter arrangement according to claim 12 further comprising:
(a) a baffle plate at an end of the housing opposite of the valve opening; the baffle plate defining an inlet arrangement and an outlet arrangement; and
(b) a spring member biasing the media pack against the baffle plate.

14. A filter arrangement according to claim 13 wherein:
(a) the spring member is located between and against the retainer and an end of the media pack.

15. A filter arrangement according to claim 11 wherein:
(a) the retainer includes an ear arrangement radially projecting from an outer perimeter thereof; the ear arrangement engaging a portion of the housing to inhibit rotation of the retainer relative to the housing.

16. A filter arrangement according to claim 11 wherein:
(a) the knob further includes a wall extending from and circumscribing the base.

17. A filter arrangement according to claim 16 wherein:
(a) the knob further includes a wing arrangement radially projecting from the wall.

18. A filter arrangement according to claim 11 wherein:
(a) the knob further includes a hollow column axially projecting from the base in a direction opposite of the tube; the hollow column defining the drain hole.

19. A filter arrangement according to claim 11 wherein:
(a) the base defines a groove circumscribing the tube and located radially between the drain hole and the tube;
(i) the seal member being seated within the groove.

20. A filter arrangement according to claim 11 wherein:
(a) the tube has a free end opposite of the base; and
(b) the aperture arrangement includes:
(i) at least a first aperture through the tube and adjacent to the base; and
(ii) at least a second aperture through the tube and located axially between the first aperture and the free end of the tube.

21. A filter arrangement according to claim 10 wherein:
(a) the knob includes tabs oriented to engage protrusions on the housing and result in an audible click when engaged against each other.

22. A method of draining a filter member including a housing containing a media pack; the method comprising:
(a) rotating a knob relative to a retainer held by a filter housing to:
(i) release a seal between the knob and the housing;
(ii) open a fluid channel between an interior of a tube and a drain hole in a base of the knob;
(A) the tube extending into a bore of the retainer and into an interior volume of the housing; and
(iii) open a vent hole extending through the tube; the vent hole being located between a free end of the tube and the fluid channel.

23. A method according to claim 22 wherein:
(a) the step of rotating includes engaging cammed threads between an exterior surface of the tube and an interior bore of the retainer.

24. A method according to claim 22 further comprising:
(a) after the step of rotating, allowing liquid to drain through the drain hole while allowing air to flow into the interior volume of the housing through the vent hole.

25. A method according to claim 24 wherein:
(a) the step of allowing liquid to drain through the drain hole includes allowing liquid to drain through a hollow column extending from the base in a direction opposite of the tube.

26. A method according to claim 22 wherein:
(a) the step of rotating includes grasping a wing arrangement on the knob.

27. A method according to claim 22 wherein:
(a) the step of rotating includes rotating the knob from a closed position to a position not more than 180 degrees from the closed position to release the seal between the knob and the housing, open the fluid channel between the interior of the tube and the drain hole in the base of the knob, and open the vent hole extending through the tube.

28. A method according to claim 22 wherein:
(a) the step of rotating a knob includes engaging the knob against a portion of the housing to create an audible click.
